(19) United States
(12) Patent Application Publication
(10) Pub. No.: US 2012/0053999 A1
(43) Pub. Date: Mar. 1, 2012

(54) Delivering Highly Targeted Advertisements Based on a Coupon-Exchanging System

(76) Inventor: Yang Pan, Singapore (SG)

(21) Appl. No.: 12/870,783

(22) Filed: Aug. 27, 2010

(51) Int. Cl. G06Q 30/00

(52) U.S. Cl. 705/14.1; 705/14.66

(57) ABSTRACT

A method of delivering highly targeted advertisements to a user of computing device is disclosed. The computing device is connectable to a data manager through a communication network. The data manager includes a coupon exchanging system for users to trade coupons through the network. A personalized file is established and updated for a user based on a history of the user using the coupon exchanging system. Highly targeted advertisements may be delivered to the computing device based on the personalized file. Coupons stored in the computing device may be displayed as a visual image. Advertising message may be displayed as a portion of the visual image.

### CROSS-REFERENCE TO RELATED APPLICATIONS

Not applicable.

### BACKGROUND

1. Field of Invention

This invention relates generally to advertising. More specifically, the invention relates to methods for delivering highly targeted advertisement to a user of an electronic system.

2. DESCRIPTION OF PRIOR ART

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising message accordingly.

### SUMMARY

It is an object of the present invention to provide a method for users to exchange electronic coupons through a communication network.

It is a further object of the present invention to provide a method of delivering a highly targeted advertisement to a user based on a history of the user using the coupon exchanging system.

It is yet another object of the present invention to provide a method of displaying advertising message on a portion of the coupon image where the message may be related to the coupon and is updatable.

According to one embodiment of the present invention, an advertisement delivery system comprises a computing device, a data manager and a communication network for connecting them. The computing device comprises a processor, a display, a file storage unit and a coupon manager. The data manager comprises a coupon exchanging system, a personalized file and an advertisement delivery manager.

After the computing device and the data manager are connected, the user may start to use the coupon exchanging system of the data manager. The user may trade coupons stored in the computing device with coupons listed in the system. The coupons may be traded using a method of auction. The user may also exchange his coupons with points of credit from the data manager and use the points to purchase new coupons. The user may also purchase coupons through an on-line payment system.

The user's history of using the coupon exchanging system is recorded by the data manager. A personalized file characterizing the user's commercial interests is established and updated based on the history. Highly targeted advertisements may be delivered to the computing device accordingly.

The coupon manager of the computing device may provide a means of displaying stored coupons in a hierarchical manner. The electronic coupon displayed as an image on the display of the computing device may include advertising messages. The advertising messages may be related to the coupon. The advertising messages may be updated time to time. According to one embodiment, the coupon is displayed on a touch-sensitive type of display screen. The action that the user touches the displayed advertising message may lead to display of next level of details of the message. The message may be delivered as text, an image, a video file and a web site.

The computing device may be a personal computer, a mobile computing and communication device and a media delivery device.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary advertisement delivery system based on a coupon exchanging system;

FIG. 2 is a schematic diagram illustrating an exemplary data structure of a personalized file including categories and sub-categories of advertisements and points indicating the user's interest levels;

FIG. 3 is a flowchart illustrating an exemplary process that a targeted advertisement is delivered to the user of the computing device based on a history of the user using the coupon exchanging system;

FIG. 4 is a flowchart illustrating an exemplary process that coupons are exchanged using the coupon exchanging system;

FIG. 5 is a schematic diagram illustrating operation of a coupon manager for displaying advertising messages.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

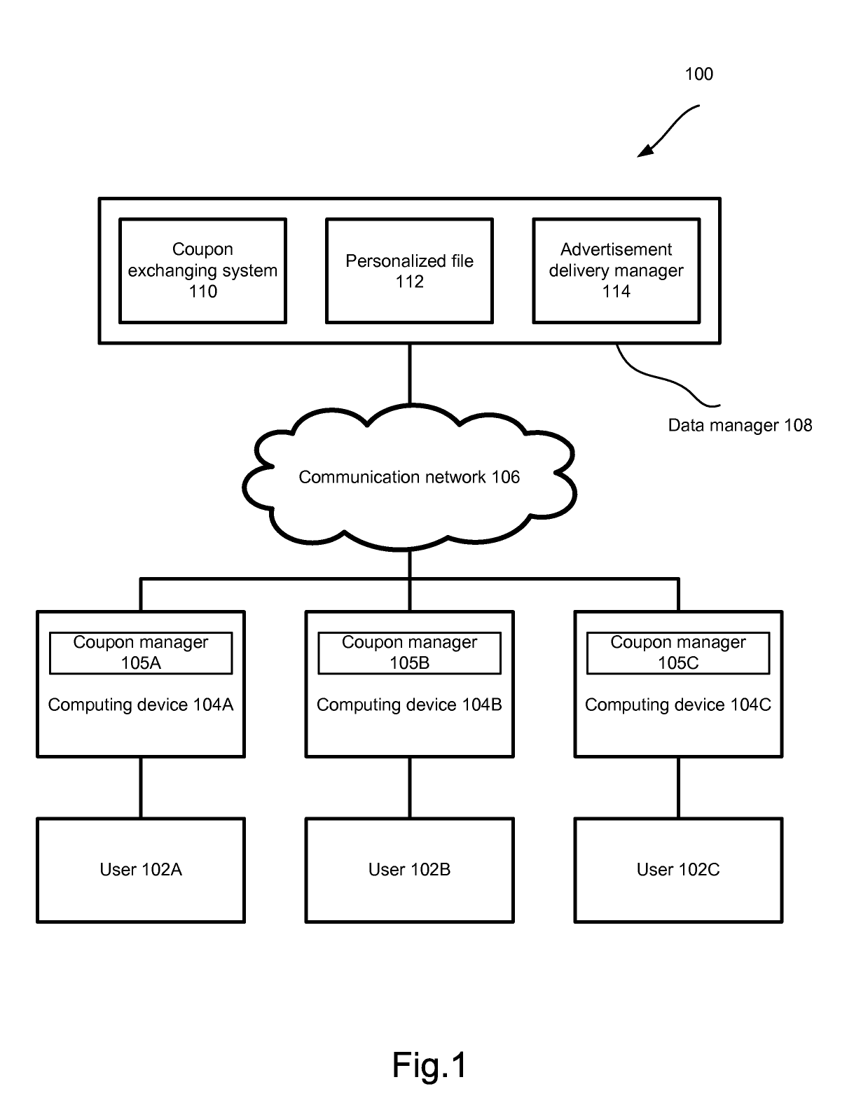

FIG. 1 is a schematic diagram of an exemplary advertisement delivery system for delivering advertisements based on a coupon exchanging system. The exemplary system 100 comprises a plurality of users 102A, 102B and 102C and a plurality of computing device 104A, 104B and 104C. The computing devices (104A-C) are connectable to a data manager 108 through a communication network 106. The data manager 108 may be a server operated by an advertiser. The communication network 106 may be the Internet. The communication network may also be a public phone network. The network 106 may even be a combination of multiple types of networks including wired and wireless ones. The computing device 104 further comprises a processor, a display, a file storage unit and a coupon manager 105. The coupon manager 105 manages stored coupons in the computing device 104. For example, the coupon manager 105 may include a hierarchical data structure for stored coupons and display the coupons in a hierarchical manner. The coupon manager 105 may also control an operation of sending and receiving coupons through the communication network 106.

The data manager 108 may further include a coupon exchanging system 110. The users may use the coupon exchanging system to exchange, to sell and to buy coupons. In an exemplary case, the user may exchange coupons in the computing device 104 with points of credit from the data manager 108. The user may use the points to purchase the coupons he desires. The user 102 may have an account in the computing device 104. The account has a record of accumulated points of credit of the user. The users may also sell or buy coupons through the coupon exchanging system 110 using an auction system such as, for example, a system used by commercial on-line auction companies as eBay. The data manager 108 may also include a personalized file 112. The personalized file 112 includes categories and sub-categories advertisements. The user's levels of interests in each one are marked based on a history of the user 102 using the coupon exchanging system 110. An advertisement delivery manager 114 may deliver targeted advertisements to the user 102 based on the personalized file 112.

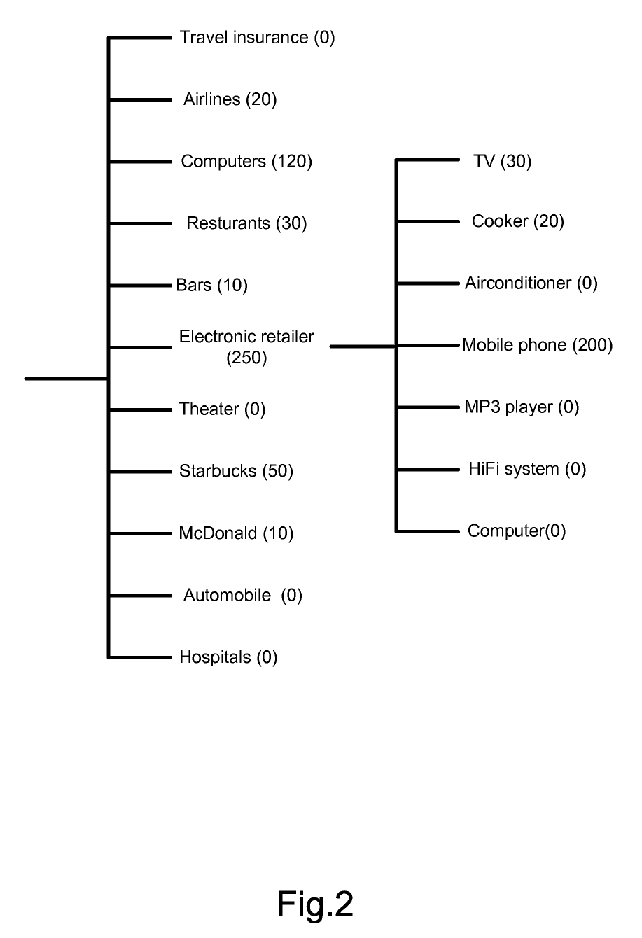

FIG. 2 is a schematic diagram illustrating an exemplary data structure of a personalized file including categories and sub-categories of advertisements. If the user 102 exchanges other coupons for the ones for electronic retailers, the points indicating the user's interest level in the category is high. The hierarchical data structure allows that the user's interest level for sub-category such as mobile phone of the category “electronic retailer” is further identified. Therefore, advertisements and promotional materials for mobile phones can be delivered to the user's computing device 104 through the communication network 106.

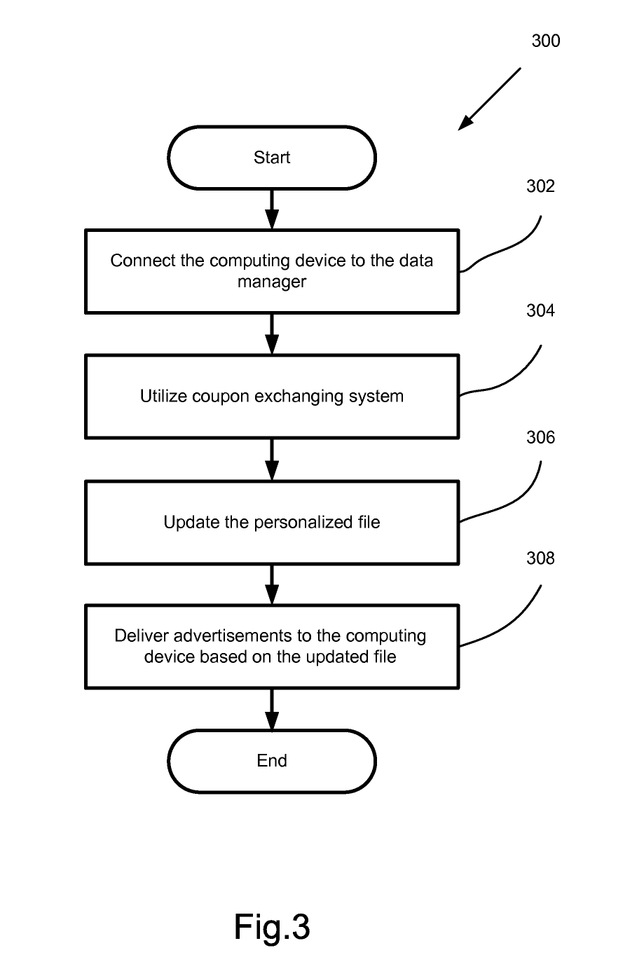

FIG. 3 is a flowchart illustrating an exemplary process that a targeted advertisement is delivered to the user 102 of the computing device 104 based on a history of the user using the coupon exchanging system 110. Process 300 starts with step 302 that the computing device 104 is connected to the data manager 108 through the communication network 106. The user 102 utilizes the coupon exchanging system 110 for exchanging, buying and selling electronic coupons in step 304. The personalized file 112 is updated in step 306 based on the user's history of using the coupon exchanging system 110. A selected number of advertisements are delivered to the computing device 104 in step 308. The advertisements may be directly related to coupons that the user exchanged for. The advertisements may also be the ones based on the history of the user using the system 110 over a period of time. The advertisements may be delivered as separate media files to the computing device 104. The advertisements may also be delivered in combination with the coupons that user receives. For example, an advertisement may be delivered as an image displayed on at least a portion of an electronic coupon. The user 102 may select the displayed advertising message for the next level of details. The next level of details may be presented as a text, an image, a video file and a web site.

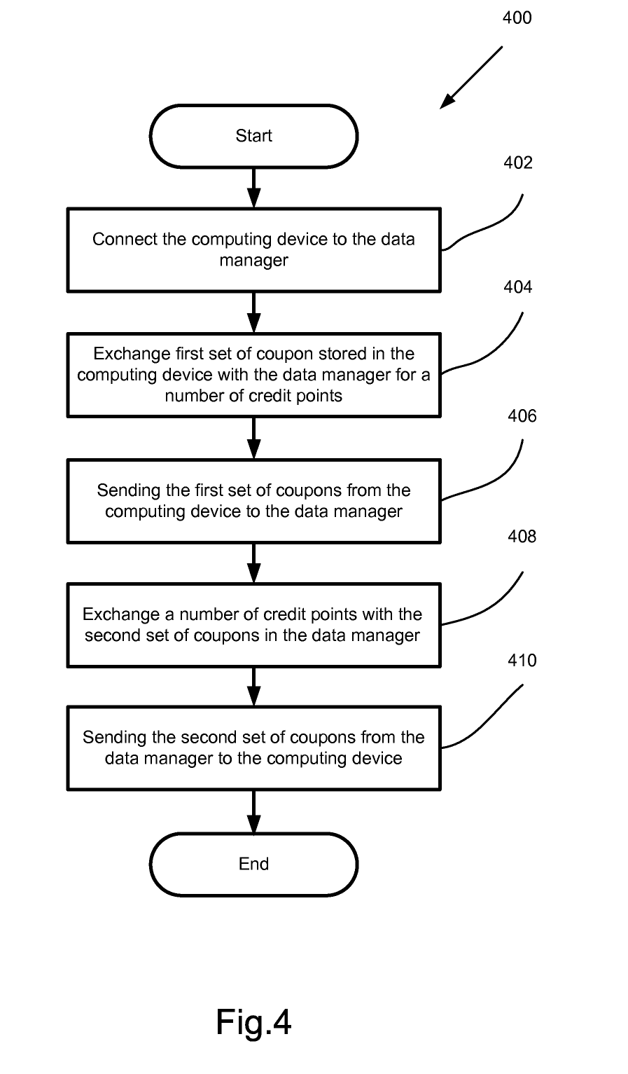

FIG. 4 is a flowchart illustrating an exemplary process that coupons are exchanged or are traded based on the coupon exchanging system 110. Process 400 starts with step 402 that the computing device 104 is connected to the data manager 108 through the communication network 106. A first set of coupons stored in the computing device 104 is exchanged for a number of points of credit with the data manager 108 in step 404. The first set of coupons is sent to the data manager 108 in step 406. The user 102 may use the points of credit accumulated in his account in the computing device 104 or in the data manager 108 to purchase a second set of coupons in step 408. The second set of coupons may be the ones the user needs to purchase desired commercial items. The second set of coupons is sent from the data manager 108 to the computing device 104 in step 410. The coupons may include advertising messages. The messages may be a part of coupon. The messages may be separated media files.

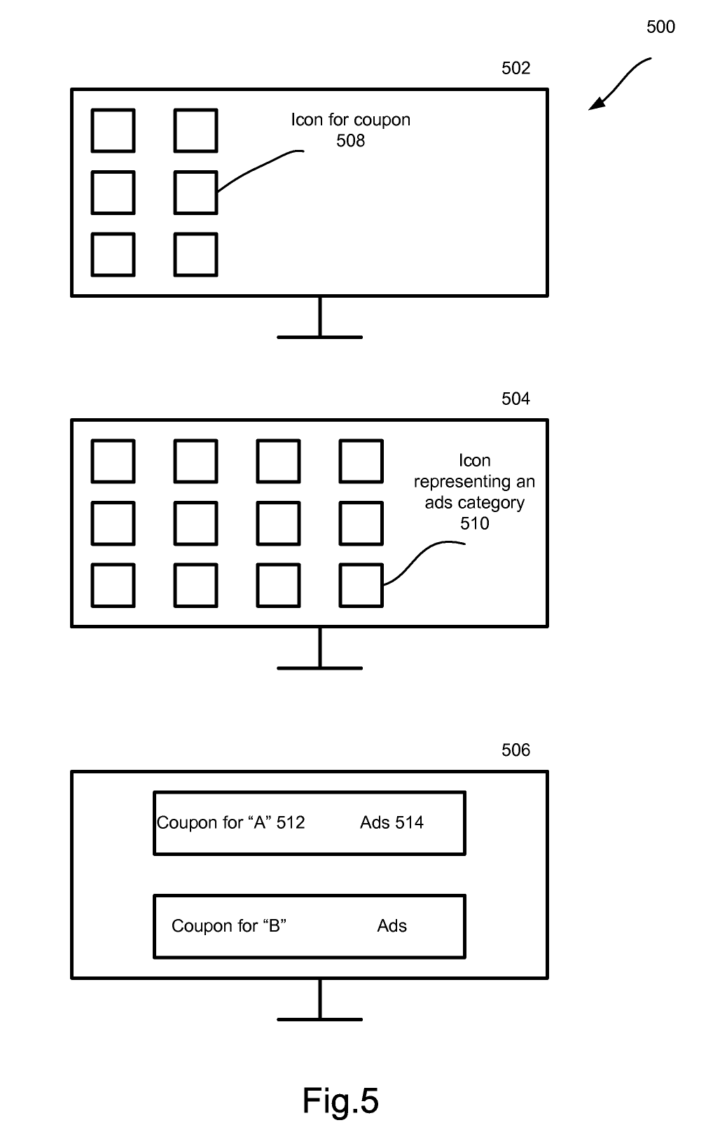

FIG. 5 is a schematic diagram illustrating operation of a coupon manager 105 of the computing device 104. The computing device 104 may include a display such as a display terminal for a computer. In step 502, a plurality of icons is displayed on the display terminal. One of the displayed icons is an icon (510) for stored coupons (508). Upon the selection of the icon 508 by the user 102, a number of icons representing different categories of commercial items are displayed as shown in 504. Each of the icons may be associated with a number of images of coupons. After the user 102 selects one of the icons, one or more than one electronic coupons may be displayed in an exemplary manner as shown 506. An electronic coupon may include messages for the coupon (512) including its value and the expiring date. The electronic coupon may also include an advertising message 514. The advertising message 514 may be an image displayed on a portion of the electronic coupon. The user 102 may select the displayed advertising message for next level of details. The next level of details may be presented as a text, an image, a video and a web site. The advertising message may be related to the coupon. The advertising message may be replaced time to time. New advertising messages may be delivered from the data manager 108 by its advertisement delivery manager 114.

While the invention has been disclosed with respect to a limited number of embodiments, numerous modifications and variations will be appreciated by those skilled in the art. It is intended that all such variations and modifications fall within the scope of the following claims:

1. A method of delivering advertisements from a data manager to a computing device through a communication network, wherein the data manager including a coupon exchanging system, the method comprising:
a. tracking a user's history of using the coupon exchanging system;
b. establishing and updating a personalized file for the user based on said history; and
c. delivering the advertisements based on the personalized file.

2. The method as recited in claim 1, wherein said computing device further comprising a processor, a display, a file storage unit and a coupon manager.

3. The method as recited in claim 2, wherein said coupon manager further comprising a means of sending and receiving a coupon through a communication network.

4. The method as recited in claim 2, wherein said coupon manager further comprising a means of displaying stored coupons on the display of the computing device in a form of icons, wherein said means of displaying further including displaying coupons in a hierarchical manner.

5. The method as recited in claim 2, wherein said coupon manager further comprising a means of displaying a coupon as a visual image, wherein at least a portion of the visual image including an advertising message.

6. The method as recited in claim 5, wherein said portion of visual image for advertising message, when selected by the user, displaying next level of details for the advertising message.

7. The method as recited in claim 5 wherein said advertising message may be related to the coupon and may be updatable.

8. The method as recited in claim 1, wherein said computing device further comprising a personal computer; a mobile computing and communication device; and a media delivery device.

9. An advertisement delivery system comprising:
a. a computing device including a processor, a display, a file storage unit and a coupon manager;
b. a data manager including a coupon exchanging system;
c. a communication network connecting the computing device and the data manager; and
d. an advertisement delivery means of delivering advertisements to a user of the computing device based on the user's history of using the coupon exchanging system.

10. The system as recited in claim 9, wherein said computing device further comprising a personal computer; a mobile computing and communication device; and a media delivery device.

11. The system as recited in claim 9, wherein said communication network further comprising the Internet.

12. The system as recited in claim 9, wherein said coupon exchanging system further comprising a means of exchanging coupons among a plurality of users of the system.

13. The system as recited in claim 12, wherein said means of exchanging coupons further comprising:
a. auctioning; and
b. buying and selling through the data manager using a points of credit system.

14. The system as recited in claim 9, wherein said coupon manager comprising a means of sending and receiving a coupon through a communication network.

15. The system as recited in claim 9, wherein said coupon manager further comprising a means of displaying stored coupons on the display of the computing device in a form of icons, wherein said means of displaying further including displaying coupons in a hierarchical manner.

16. The system as recited in claim 9, wherein said coupon manager further comprising a means of displaying a coupon as a visual image, wherein at least a portion of the visual image including an advertising message.

17. The system as recited in claim 16, wherein said portion of visual image for advertising message, when selected by the user, displaying next level of details for the advertising message.

18. The system as recited in claim 16, wherein said advertising message may be related to the coupon and may be updatable.

19. A method of exchanging coupons through an electronic system including at least one computing device, at least one data manager and at least one communication network, the method comprising:
a. exchanging first set of coupons with the data manager for a predetermined number of credit points;
b. sending the first set of coupons from the computing device to the data manager;
c. exchanging a predetermined number of credit points with data manager for second set of coupons; and
d. sending the second set of coupons from the data manager to the computing device.

20. The method as recited in claim 19, wherein said step of “sending” coupons from the data manager to the computing device may be accompanied with transmitting at least one advertising message.
